(19) United States
(12) Patent Application Publication
(10) Pub. No.: US 2010/0130212 A1
(43) Pub. Date: May 27, 2010

(54) Femto Cell Handover In Wireless Communications

(75) Inventors: Tricci So, San Diego, CA (US); Jerry Pak Lup Chow, San Diego, CA (US); Jianquan Song, ShenZhen (CN); Li Chu, ShenZhen (CN); Wen Luo, Nanjing (CN); Yangwei Tu, Nanjing (CN)

Correspondence Address: FISH & RICHARDSON, PC, P.O. BOX 1022, MINNEAPOLIS, MN, 55440-1022, US

(73) Assignee: ZTE (USA) INC., Iselin, NJ (US)

(21) Appl. No.: 12/605,286

(22) Filed: Oct. 23, 2009

Related U.S. Application Data
(60) Provisional application No. 61/108,003, filed on Oct. 23, 2008.

(51) Int. Cl. H04W 36/00

(52) U.S. Cl. 455/444

(57) ABSTRACT

Techniques, apparatuses, and systems can include determining one or more handover base station candidates for a specific mobile station associated with a serving base station based at least on respective one or more proximities of the one or more handover base station candidates to the serving base station and one or more base station access privileges associated with the mobile station.

### PRIORITY CLAIM AND CROSS REFERENCE TO RELATED APPLICATION

This document claims the benefit of the priority of U.S. Provisional Application Ser. No. 61/108,003, filed Oct. 23, 2008 and entitled “FEMTO CELL HANDOVER IN WIRELESS COMMUNICATIONS,” the entire contents of which is incorporated by reference as part of the disclosure of the this document.

### BACKGROUND

This document relates to wireless communication systems and techniques.

Wireless communication systems use electromagnetic waves to communicate with fixed and mobile wireless communication devices, e.g., mobile wireless phones and laptop computers with wireless communication cards, that are located within cells of coverage areas of the systems. Base stations are spatially distributed to provide radio coverage in a geographic service area that is divided into radio cells. In operation, a base station transmits information to a wireless subscriber stations such as a mobile station via a base station generated downlink radio signals. A mobile station at a particular cell transmits information to its serving base station for that particular cell via uplink radio signals. The base stations can include directional antennas to further divide each cell into different cell sectors where each antenna covers one sector. This sectorization of a cell increases the communication capacity.

Various wireless communication systems can include a network of one or more base stations to communicate with one or more wireless devices such as a mobile device, cell phone, wireless card, mobile station (MS), user equipment (UE), access terminal (AT), or subscriber station (SS). A base station can be referred to as an access point (AP) or access network (AN) or can be included as part of an access network. Further, a wireless communication system can include one or more access networks to control one or more base stations.

In some wireless communication networks, the base stations may be configured to in a multi-tier configuration. For example, a base station may placed in a radio cell of another base station to provide radio coverage of a small section of the radio cell. In this case, the large cell can be considered as a macrocell because another base station is located within the macrocell region and the smaller cell inside the macrocell can be considered a microcell. This macrocell-microcell configuration can expand the radio coverage of the network and can increase the radio frequency bands and thus the communication capacity of the network. One macrocell can include one or more microcells depending on the needs for radio coverage in that macrocell. This tiered base station configuration can further include picocells each providing radio coverage in a small region within a microcell.

A wireless device can use one or more different wireless technologies for communications. Various examples of wireless technologies include Code division Multiple Access (CDMA) such as CDMA2000 1x, High Rate Packet Data (HRPD), evolved HRPD (eHRPD), Universal Mobile Telecommunications System (UMTS), Universal Terrestrial Radio Access Network (UTRAN), evolved UTRAN (E-UTRAN), Long-Term Evolution (LTE), and Worldwide Interoperability for Microwave Access (WiMAX).

### SUMMARY

This document includes, among other things, techniques and systems for performing handover of a mobile station between a cellular wireless network and a private cell or private network.

In one aspect, techniques for performing handover can include operating a macrocell base station to provide wireless service to mobile stations, determining a candidate group of one or more femtocell base station candidates based at least on respective one or more proximities to the macrocell base station to perform a handover of a mobile station that is being served by the macrocell base station, causing the mobile station to take measurements of signals from one or more base stations identified by the candidate group, and selecting a target femtocell base station from the candidate group for the handover based on the measurements. The one or more femtocell base station candidates can provide wireless service in respective coverage areas that are smaller than a coverage area of the macrocell base station. Other implementations can include corresponding systems, apparatus, and computer programs, configured to perform the actions of the techniques, encoded on computer readable mediums.

These and other implementations can include one or more of the following features. Determining the candidate group can include selecting one or more private femtocell base stations based on one or more access privileges that grant access to the mobile station to communicate with the respective one or more private femtocell base station. Determining the candidate group can include selecting one or more one public femtocell base station candidates. Implementations can include prioritizing the candidate group based on one or more access privileges associated with the mobile station.

Causing the mobile station to take measurements can include causing the mobile station to use a result of the prioritization to direct the taking of measurements. Causing the mobile station to take measurements can include causing the mobile station to use a service provisioning information to direct the taking of measurement, wherein the service provisioning information indicates a preferred base station scanning order. Selecting the handover femtocell base station can include operating the mobile station to select the handover femtocell base station based on the measurements. Implementations can include receiving the measurements from the mobile station, where selecting the handover femtocell base station can include selecting the handover femtocell base station based on the received measurements. Causing the mobile station to take measurements of base station signals can include transmitting a unicast mobile neighbor base station advertisement over a unicast channel to the mobile station. The unicast mobile neighbor base station advertisement can include one or more base station identifiers associated with one or more base stations included in the candidate group.

Implementations can include transmitting a broadcast mobile neighbor base station advertisement over a broadcast channel to multiple mobile stations. The broadcast mobile neighbor base station advertisement can include one or more base station identifiers associated with the macrocell base station's one or more neighboring macrocell base stations. Implementations can include transmitting one or more base station identifiers associated with one or more base stations included in the candidate group in a unicast mobile neighbor base station advertisement over a unicast channel to the mobile station.

Implementations can include providing to the target femtocell base station one or more identities of base stations that are potential handover targets from the target femtocell base station for the mobile station. The one or more identities of base stations can include an identity of a femtocell base station that grants wireless access to the mobile station. The one or more identities of base stations can include an identity of a macrocell base station that grants wireless access to the mobile station.

In another aspect, techniques for performing handover can include determining one or more handover base station candidates for a specific mobile station associated with a serving base station based at least on respective one or more proximities of the one or more handover base station candidates to the serving base station and one or more base station access privileges associated with the mobile station; and providing handover candidate information to the serving base station, wherein the handover candidate information includes one or more identities corresponding to the one or more handover base station candidates. Other implementations can include corresponding systems, apparatus, and computer programs, configured to perform the actions of the techniques, encoded on computer readable mediums.

These and other implementations can include one or more of the following features. Implementations can include operating a cellular wireless network to provide wireless service to mobile stations via one or more macrocell base stations and to communicate with femtocell base stations associated with the cellular wireless network. The femtocell base stations can provide wireless service in respective coverage areas that are smaller than a coverage area of a macrocell base station with the serving base station being one of the femtocell base stations. Implementations can include providing updated handover candidate information to the serving base station based on a change of availability of handover base station candidates to server the mobile station.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of a wireless communication system.

FIG. 2 shows an example of a radio station architecture.

FIG. 3 shows an example of hierarchical cells in a wireless network architecture.

FIG. 4 shows an example of a flow of operations for handover from a macrocell to a private cell.

FIG. 5 shows an example of a handover operation between a macrocell and a femtocell.

FIG. 6 shows an example of providing handover candidate information

Like reference symbols in the various drawings indicate like elements.

### DETAILED DESCRIPTION

Various private wireless networks, separate from public wireless networks for providing mobile communication services to the general public, are becoming popular. Such private networks provide radio cells that cover selected service areas such as a home, one or more offices, and a corporate or university campus and can provide wireless services in conjunction with public wireless networks. This combination of public and provide networks can be used to provide a higher quality mobility environment for the user within areas in which the user wishes to maintain communications while on the move. Handovers between a macro-cellular network and smaller and localized cells of private networks are needed to provide continuous communications for users that use both the macro-cellular network and a private wireless network. The radio coverage organization that needs to be considered for these types of handovers can be different than in traditional wireless networks. Instead of cells predominantly organized to provide radio coverage to adjacent areas, there are now potentially many smaller cells within the coverage area of the macro-cell. In addition, access to the smaller underlying cell or network is typically restricted to a small subset of the users of the macro-cellular network.

In the examples described below, a cell represents a radio coverage area that may require a handover to maintain communications continuity as a mobile station moves into the radio coverage area. For example, a cell can include an omni-cell or sectors of a sectorized cell in a real-world deployment and operations and processing by a cell are performed by a base station associated with that cell. A macrocell is a cell in a wireless network to which the entire population of users of the wireless network has the right and privileges to access. A private cell or a private network in the following examples has restricted access for only selected users and examples for such private cells or private networks include femto cells and home wireless access points. Such a private cell or a private network has certain characteristics that are different from those of traditional wireless networks. Thus, in private cells and networks such as the home-area, office-area and campus cells or networks, techniques to support handover from one cell to another used in a microcell network can be inefficient in handling handover between a macro cell network and a private network.

For example, one feature in some traditional handover mechanisms that do not scale well to support handover between a macro cell network and a private network is the use of neighbor lists that are considered generally applicable to all users in the coverage area. More specifically, there can be a large potentially large number of the underlying cells and the neighbor list applicable to the overlying macrocell can become large and broadcasting of this large neighbor list to assist mobile stations to determine potential target cells may consume significant over-the-air capacity. Notably, a underlying cell may admit only a small subset of users and prohibit access by other users, including and advertising all such cells in the general neighbor list makes determination of a target cell for handover by all mobile stations inefficient because non-applicable entries are received and processed and there is no mechanism for the MS to determine which neighbors are applicable to it for the handover.

For another example, various macrocell mobile networks use autonomous MS scanning to determine the best prospective candidate cell(s) for handover. Since a cell in the list may admit only a small subset of users and prohibit access by other users, the MS may be forced to evaluate and propose potential handover target cells to which it cannot successfully have access when the MS is not provided with information on the subset membership and accessibility of cells.

This application describes, examples and implementations of techniques and network designs that provide efficient handover between a macro cell network and a private network. In general, the overall system interactions described here between the private cell/network and the macro cell network applies also between the private cell/network and pico or micro cell network. Therefore, whenever the reference of the macro cell described herein shall also apply to the picocells and microcells.

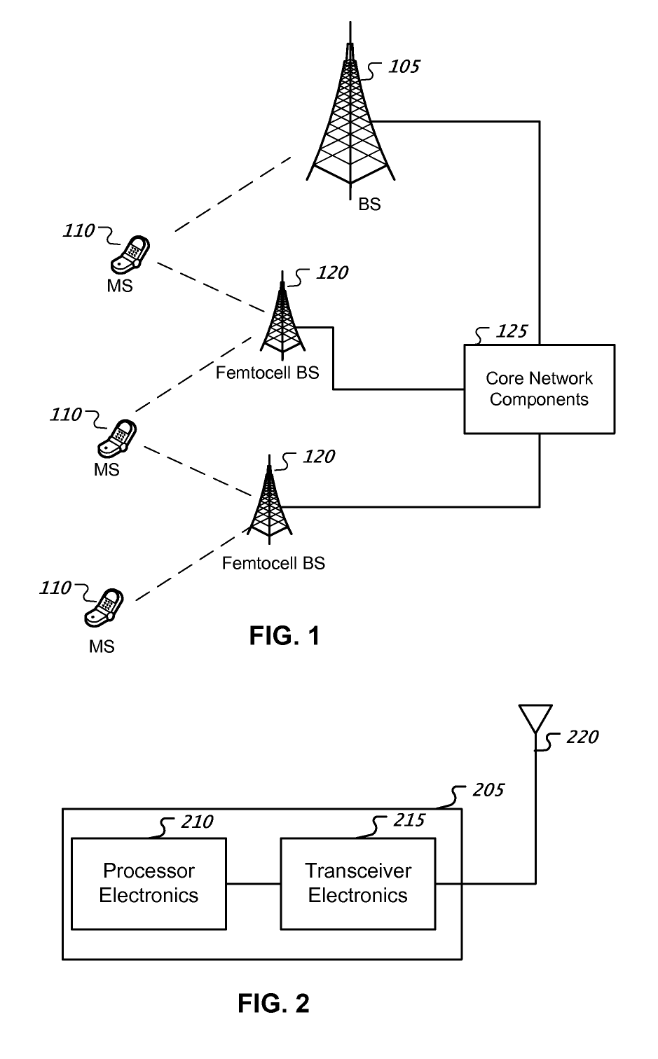

FIG. 1 shows an example of a wireless communication system. A wireless communication system can be referred to as a wireless network. A wireless communication system can include a base station such as a macrocell base station 105, microcell, or picocell base stations and can include one or more core network components 125 such as servers to provide information on handover candidates. Multiple femtocell base stations 120, which can be referred to as femto-cell wireless access points (WFAPs), can be located within a geographical area of the macrocell base station 105. The macrocell base station 105 and femtocell base stations 120 can provide wireless service to wireless devices such as mobile stations 110 (MSs).

Various examples of wireless communication systems that can implement the present techniques and systems include, among others, wireless communication systems based on Code division Multiple Access (CDMA) such as CDMA2000 1x, High Rate Packet Data (HRPD), evolved HRPD (eHRPD), Universal Mobile Telecommunications System (UMTS), Universal Terrestrial Radio Access Network (UTRAN), Evolved UTRAN (E-UTRAN), Long-Term Evolution (LTE), and Worldwide Interoperability for Microwave Access (WiMAX). In some implementations, a wireless communication system can be based on IEEE 802.16m.

FIG. 2 shows an example of a radio station architecture. A radio station 205 such as a base station or a wireless device can include processor electronics 210 such as a microprocessor that implements methods such as one or more of the techniques presented in this document. A radio station 205 can include transceiver electronics 215 to send and/or receive wireless signals over one or more communication interfaces such as an antenna 220. A radio station 205 can include other communication interfaces for transmitting and receiving data. A radio station 205 can include one or more memories configured to store information such as data and/or instructions.

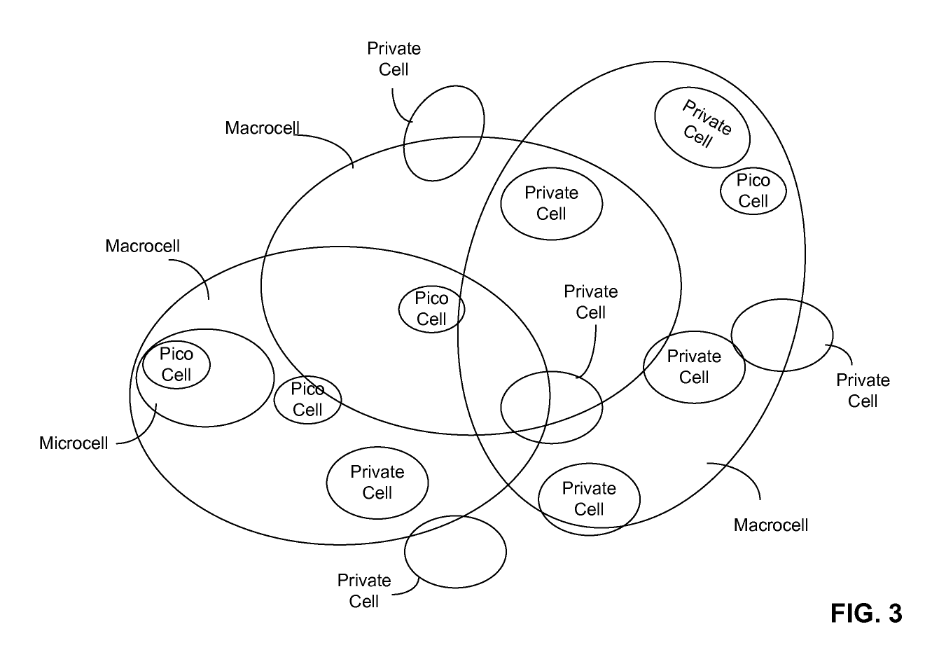

FIG. 3 illustrates an example of hierarchical cells in a wireless network deployment scenario. Multiple macrocells are provided in the service coverage region for access by all subscribed users. Microcells and picocells that are accessible by all subscribed users are also illustrated. Private cells and networks in FIG. 3 are different from macrocells, microcells and picocells and are private in that only a subset of subscribed users for the macro-cellular network can access. Because access is limited, the control of which users can be allowed access to private cells and networks is administered separately from the subscription for access to the macro-cellular network. In one implementation, for example, the access control in the underlying cell or network can be done by using an Access Control List (ACL) to determine the right for a user device to access the cell or network based on a discernable identifier, such as a MAC address, in protocol messages sent by the device. In another implementation, the access control can be a full authentication and authorization of both device and user.

In the examples in this application, it is assumed that the administrative relationship between the underlying private cell or network and the macro-cellular network includes the following characteristics. First, there is a business arrangement whereby the users accessing the private underlying cell or network has subscription to the macro-cellular network for wireless access when service cannot be provided from the private cell or network (i.e. moving out of the coverage area of the underlying cell or network). One example for this type of relationship is that the underlying private cell or network and the macro-cellular network can be operated by the same business entity. Second, there is a trust relationship between the administrative entity of the underlying private cell or network and the operator of the macro-cellular network such that any addition of users granted access to the underlying private cell or network is communicated to the administrative system of the macro-cellular network and the user is identified by an identifier that can be associated by the macro-cellular network to an authenticated user and device. Third, the macro-cellular network has knowledge of the geographic location and coverage area of a underlying private cell and network. With this knowledge, the macro-cellular network can map the location of the private cell or the location of one or more border cells of a private network to the coverage area of the macro-cells of the macrocell cellular network.

The present handover techniques can be used to augment and supplement existing mechanisms of neighbor lists and autonomous MS scanning for potential handover targets with other mechanisms to provide efficient, effective and fast determination of a private cell or network as a potential handover while the MS is being served by a respective overlying macrocell in the macrocell cellular network. In the macro-cell, the neighbor list is maintained for other adjoining macro-cells but no neighbor list entries are added for the underlying private cells, or one or more cells of a private wireless network that are considered to be border cells between this private network and the macrocell network. Notably, relevant operational information for each MS being served is kept at the serving macrocell to facilitate the efficient, effective and fast determination of an underlying cell as a potential handover target in a private cell or network.

The above relevant operational information for each mobile station kept at the serving macrocell includes the identity of underlying private cells within the coverage area of the macrocell that the user of the MS has permission to access. With this information, the macrocell can use the network-initiated scanning to instruct the MS to take and report measurements on the identified underlying private cells for which the MS has permission to access. Based on these measurement reports, the macrocell can determine when to instruct the MS to perform a handover to a permitted underlying private cell based on a handover policy. One example for such policy is to always force a handover to the permitted underlying private cell as long as the estimated service is deemed to be acceptable in the underlying cell. Another policy may be to use the foregoing policy as a base policy amended with the exception if the speed of the MS is determined to be greater than a certain limit such as 10 miles per hour as an example. Many policy variations may exist and can fit into this decision framework. The MS can be operated based on existing mechanisms defined by the technology or by other means, such as some manual indication by the user and the MS may initiate handover to the permitted underlying private cell. The macrocell network can leverage the operational information described above to support the MS's decision for the appropriate handoff target private cell For example, the user may depress a key or otherwise execute a command of the MS device to force the macro-to-private cell handover. For another example, the MS detects that the certain handover decision threshold has been reached and then initiates the handover to a potential target private cell.

In one implementation, a handover mechanism can be implemented to include the following aspects. First, a macro-cellular network is configured to learn and obtain the information that a user MS has been granted access to an underlying private cell or network, to maintain this information for future use, and distributes such information as needed to internal parts of the macrocell network for immediate use. Second a mechanism for determining the applicable underlying private cells for each user MS being served by a macrocell is provided. Third, a mechanism is provided to obtain measurements of the underlying private cells applicable to a user MS for evaluation of a potential handover target without the need to include such cells in the neighbor cell list.

An example for obtaining macrocell knowledge of the private cell membership is now described. It is presumed that by default an underlying private cell/network does not allow any general users to access its network and that a method is provided locally at the private cell/network to provision access privileges for new users and devices. As an example for implementing such a method, an Access Control List (ACL) may be provided whereby the MAC addresses or other kind of unique identifiers of wireless communications devices associated with authorized users are entered. As another example for implementing such a method, secure private information associated with each authorized user that is compatible with a secure authentication and authorization protocol supported by the wireless technology may be entered into an Administration, Authentication and Authorization (AAA) database.

Under an existing trust relationship between the administrative entity of the underlying private cell/network and the macro-cellular network, whenever a new user is granted access to the private cell/network by being provisioned with access privileges, the private cell/network provides the macro-cellular network with this information that associates permission for access to the specific private cell/network (as identified by an agreed-to cell or network identifier) by a specific user as identified by an agreed-to user identifier (which may be the identifier of a device associated with the user). This information exchange can occur via various means. For example, this exchange can be a person to person communications. For another example, this exchange can occur autonomously via a signaling protocol between the private cell/network and the macro-cellular network.

In operation, the macro-cellular network is kept up-to-date as to the current list of users each being granted access to a particular private cell/network. Using this information and the knowledge that the macro-cellular network has on the geographic location and coverage area of the specific underlying private cell or private network, the macro-cellular network can be operated to associate the user with the specific private cell, or border cells of the private network, and the specific macro-cells within its network that can be involved in handovers from the macro-cellular network to the private cell/network.

In response to a change to the list of users granted access to a private cell/network, the macrocell network can be operated to include one entry for a user who is newly granted for access to a private cell or network into the macro-cellular networks operational data associated with the user and this entry includes the cell ID for the private cell or each of the one or more border cells in a private network, and Macro Cell IDs for macrocells, if any, from which the user may perform handover to the Private Cell or to which the user may perform handover from the Private Cell. When there are no macrocells suitable for handover with a private cell or private network, the entry for the Macro Cell ID can be set zero to indicate that mobility service cannot be provided from the macro-cellular network to this particular Private Cell. In this case, nomadic service may be provided to the user.

Any new such Private Cell entries are incorporated into the user's macro-cellular subscriber operational information. In one implementation, this information can be maintained as part of the subscriber profile information and stored at the Home AAA (H-AAA) function from where the full set of Private Cell ID information (along with other necessary configuration and operational information associated with the user) come into effect each time the user is successfully authenticated for service. If the user is already active in the macro-cellular network and the macrocell at which the user is currently being served is one of the cells from which handover can be performed to the Private Cell, the new Private Cell ID is provided to the serving macrocell to be added as a potential Private-Cell handover target for the user. This information may also be added to the handover context information that will be transferred to the target cell if the target is a macro-cell.

Various mechanisms can be provided for a macrocell to obtain the applicable Private Cell information for a user when the user is served by the macro-cell. In one example for such mechanisms, the macrocell queries a more centralized location/function in the network for any such information for the user. This more centralized location/function may be the H-AAA itself or private cell gateway to allow the local agent of the private cell at the current serving access network to provide such information to support the handoff operation for the appropriate user.

In another example for such mechanisms, when the user enters the macrocell on handover, the full set of Private Cell IDs and their associated macro-cells can be directed to the macrocell as part of the handoff context information from the previous serving macro-cell. From this data received b the macrocell, the macrocell can determine whether the user has any Private Cells within the macro-cell's coverage area to which the user has access privileges. The H-AAA or the private cell gateway can be operated to push the access privilege information to the local agent of the private cell at the access network. This operation can be used to ensure that the handoff context is kept up-to-date as the private cell/network may add or delete new user to access the private cell/network while the user has been active with the current serving access network. Consequently, the handoff context of the corresponding user will be updated with the access privilege to the private cell.

Based on the above updated information on the private cells or private network, the handover target can be selected from the private cells or networks identified in the above private cell mapping for handover from a Macrocell to a Private Cell Based on the information acquisition, processing, and dissemination process described in this specification, a macrocell knows that a user currently being served by the macrocell has permission to access one or more Private Cells to which the macrocell is able to support handover.

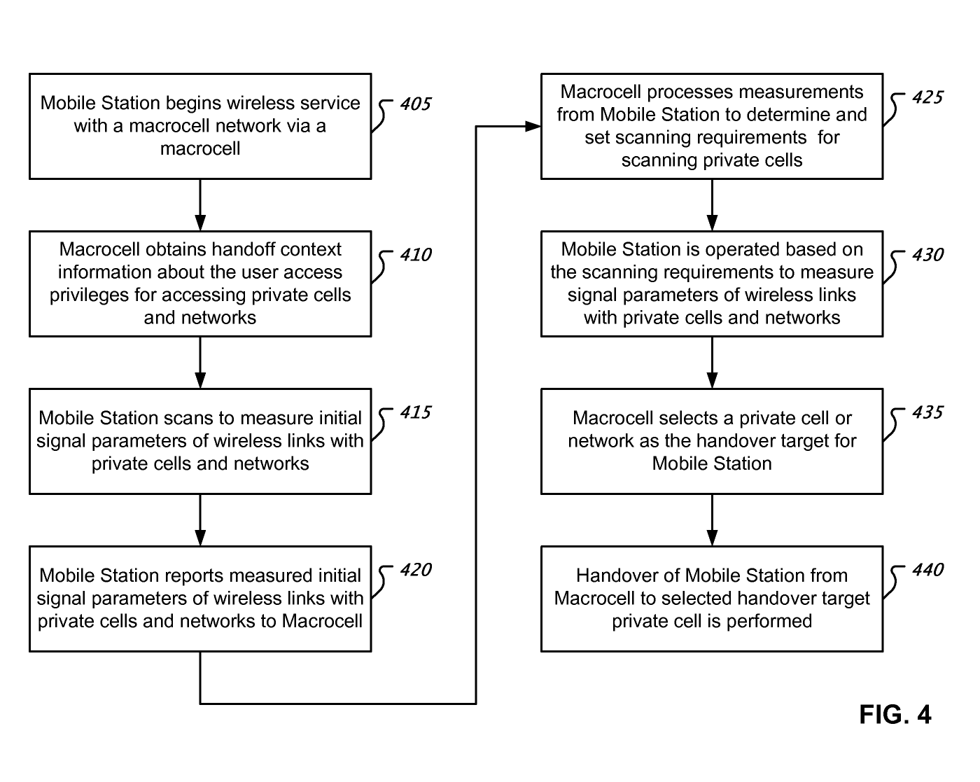

FIG. 4 shows an example of a flow of operations for handover from a macrocell to a private cell. This example illustrates a procedure between the macrocell and the user's MS in order to allow these Private Cells as potential handover targets without the necessary support by the advertised neighboring cell list.

A user MS begins the wireless service from the access network via a macrocell (405). This can occur via a number of ways including 1) a handover from another macrocell or from an underlying Private Cell, 2) a re-entry or re-activation into the network from a MS idle state, or 3) from a full entry activation into the network on the MS's first access attempt or after the MS was previously de-activated (such by the MS having been powered off) and is then re-activated.

On completion of the network entry or re-entry procedure, the macrocell obtains handoff context information about the user's access privileges to all Private Cells to which the macrocell can support handover (410). There are a number of methods whereby this information is obtained and the particular implementation may choose to use one or more of these methods based on system performance, cost, and complexity considerations.

If the Private_Cell_Scan_List for the user is not empty, then MS is instructed by the macrocell using network-initiated target cell scanning procedures provided by the wireless technology to report an initial set of measurement for each of the Private Cells in the list (415). These measurements aids the evaluation of relative likelihood that one of the Private Cells is more likely a handover target than others. These measurements can include, for example, RSSI (Received Signal Strength Indication) and CINR (Carrier to Interference and Noise Ratio).

Alternatively, the Private_Cell_Scan_List can be used to build a set of private neighbor cell information that is installed in the MS. Each MS which has access privileges to one or more private cell/networks can have its own set of private neighbor cell information—that is, as opposed to the general macrocell neighbor list, this information is not available to other MSs. The information contained in each entry of this private cell neighbor list may be similar to the information in the general macrocell neighbor list to provide sufficient information for the MS to perform scanning (such as carrier frequency and basic cell identification), for target handover selection (such as signal quality thresholds), and to support fast handover (such as critical physical and MAC layer communications parameters). After the mobile station initiates the scan of the private cells on the list, the mobile station can process the measurements of the signal qualities with different private cells and select one or more candidates for the handover target private cell. Next, the mobile station communicates the selected one or more candidates to the base station of the macrocell and the macrocell can evaluate this information and make a final selection of the target private cell for the handover.

In addition, the private cell neighbor information can contain handover/cell-selection policy information such as the priority for selection of a private cell versus other private cells or versus the macro-cell. The MS uses this private cell neighbor information to augment the general macrocell neighbor information that it receives normally as broadcast information from the macro-cell. The private cell neighbor information can be provisioned statically or semi-statically in the MS if the information for all private cells to which the MS has access privileges are provided where the information may only change when the MS gains or loses access privileges to private cells or when any private cell neighbor information is changed.

The private cell neighbor information can also be maintained dynamically when only a subset of the private cell neighbor information, such as those which are within the coverage area of a group of one or more macro-cells, are provided to the MS at any time and this corresponds to the scenario where Private_Cell_Support_Zones are defined. Such dynamic updating can occur via signaling from macrocell to MS when MS acquires service from a particular macrocell either via entry or re-entry into the network at or via handover to the particular macro-cell, and such signaling is only necessary if the MS does not already have the appropriate set of private cell neighbor information, where the appropriateness of such a set may be identified by a code (e.g. Private_Cell_Support_Zone_ID). When private cell neighbor information is installed in the MS, it may proceed with scanning for private cell neighbors without being instructed explicitly by the macrocell and may report back scan measurement results or propose handover candidates to the macrocell based on particular configurations in the neighbor information which is similar to its operation based on the general macrocell neighbor list.

The MS performs the requested measurements when it is not otherwise busy supporting communications active for the user (420). At least once when all requested measurements are complete or also when requested intermediate results are available, such measurements are reported back to the macro-cell.

The macrocell processes the measurement results and determines scanning requirements for each Private Cell in the Private_Cell_Scan_List according to the relative likelihood as a potential handover target if this is apparent (425). If not, the scanning settings can be set the same for all Private Cells.

The mobile station can be operated based on the scanning requirements to measure signal parameters of wireless links with private cells and networks (430). In some implementations, after collecting sufficient measurements to gain confidence of validity and stability of wireless links with private cells and networks on the list and if the MS is not in a handover hold off period that may be in effect to prevent excessive handover ping-ponging, the macrocell evaluates the results for all Private Cells in the Private_Cell_Scan_List to determine if any of the targets meets configured handover target selection criteria, e.g., such RSSI is greater than a RSSI_Threshold and CINR is greater than a CINR_Threshold. If MS is in a handover hold off period, the first evaluation occurs upon expiry of the holdoff period.

The macrocell can select a private cell or network as the handover target for the mobile Station (435). In some implementations, if one or more Private Cells meet their respective target selection criteria, the one that should provide best service can be selected as the handover candidate which can be the Private Cell for which the highest CINR is measured. The handover target selection can also be conditioned by policy-based criteria, such as a Private Cell designated as a Home Private Cell having priority in selection versus one without this designation.

Handover of the mobile station from the macrocell to the selected handover target private cell can be performed (440). In some implementations, the handover from the serving macrocell to the selected handover target private cell can be performed based on a network-initiated handover as defined by the wireless technology.

The above handover processes for handover of a MS from a macrocell to a private cell or network is based network initiated handover processes. Alternatively, the MS can also leverage the procedures and information collected as described above to conduct the MS initiated handover procedures towards the target private cell.

In the above example for the handover process, the serving macrocell can obtain the handoff context information about the user access privileges for accessing private cells and networks via various techniques. Several examples are described below.

In an example where the user MS has begun service at the serving macrocell as a result of completion of handover, the full set of mapping of macro-cells can be transferred from the prior serving macrocell to the current serving macrocell as part of the MS's Handover Context information. This information can support MS's handover decision to each Private Cell which is the neighbor of the current serving BS and the user of the corresponding MS has access privileges to the base station of the new target private cell that the MS can handover to. The current serving macrocell processes the list of Private Cell(s) to macro-cell(s) mapping information and determines to which of these Private Cells which are the neighbors of the current serving macro-cell, if any, the user & MS can potentially perform handover. In addition, the list of the potential Private Cells that the MS has the access privilege may be prioritized to optimize the network-initiated scanning and/or the network-initiated handover decisions. If there is not a single suitable private cell or network, then the remainder of this Private-Cell specific handover target selection procedure does not take effect (i.e. this procedure is exited). If one or more suitable target private cells or networks are present, then the identities of these Private Cells are inserted into a new list, Private_Cell_Scan_List, as possible Private Cell handover targets. If these Private Cells have been prioritized, the list shall be organized according to the priorities that were assigned.

If the procedure above is deemed to involve too many Private Cell entries (i.e. the user has been granted access to many Private Cells) that can cause the MS's Handover Context to become excessively large if the information for all these Private Cells were included, the macro-cells can be organized into subsets called, Private_Cell_Support_Zones, which are identified by a Private_Cell_Support_Zone_ID. Each macrocell is assigned to a specific Private_Cell_Support_Zone for a given user, and therefore, has associated with it a Private_Cell_Support_Zone_ID. Some pre-processing of the full set of Private Cell to macrocell mapping information for the user & MS has been done elsewhere within the macro-cellular network to divide this large full set into a reasonable number of subsets of smaller size based on the partitioning of all macro-cells in the macro-cellular network into reasonable Private_Cell_Support_Zones for a given user. These subsets of mapping data are cached at some location in the macro-cellular network from which individual macro-cells can query for the subset belonging to a particular Private_Cell_Support_Zone.

In operation during handover, the Private_Cell_Support_Zone_ID, if assigned, is provided by the potential target cell to the current serving macrocell during the handover preparation procedure. if the handover target belongs to the same Private_Cell_Support_Zone as determined by having been assigned the same Private_Cell_Support_Zone_ID, the current serving macrocell includes the subset of Private Cell to macrocell mapping information that it has and passes it to the target macrocell as part of the MS's Handover Context information and the procedure can be completed based what is described above. If the handover target does not belong to the same Private_Cell_Support_Zone as determined by having been assigned different Private_Cell_Support_Zone_IDs, the current serving macrocell does not include any Private Cell to macrocell mapping information and therefore, upon completion of handover, the procedure continues as described below.

If the macrocell does not have any Private Cell to macrocell mapping information after the user MS completes the network entry or re-entry, the macrocell proceeds to obtain the mapping information from some more centralized location/function within the macrocell network. In this type of scenario, the procedure can proceed in various ways. Two example are described below.

In the first example where the procedure implementation requires that the macrocell retrieves the Private Cell to macrocell mapping information from the more centralized location/function, even on completion of handovers meaning that this mapping information is never included in the Handover Context information, then the follow two alternative procedures or other procedures can be applied.

In the first procedure, some processing takes place or pre-processing has taken place at the more centralized location/function such that the macrocell is provided only with the list of Private Cells to which the user has access privileges and to which the macrocell can support handover. If no Private Cells are provided to the macrocell in response to query from macrocell to the more centralized location/function, then the remainder of this Private-Cell specific handover target selection procedure does not take effect (i.e. this procedure is exited). If one or more is provided, then the identities of these Private Cells are inserted into a new list, Private_Cell_Scan_List, as possible Private Cell handover targets.

In the second procedure, the full set of the Private Cell to macrocell mapping information for the user is passed to the macrocell and the macrocell itself processes and retains for use the subset of Private Cells to which the user has access privileges and to which the macrocell can support handover. The processing of this full set of mapping information can be performed as described above.

In the second example where the procedure implementation intends to include the Private Cell to macrocell mapping information as part of the Handover Context information, several mechanisms can be provided. In one example where the macrocell is not assigned a Private_Cell_Support_Zone_ID, then the full set of Private Cell to macrocell mapping information for the user is obtained from the more centralized location/function and is retained as part of the MS's Handover Context information (either at the macrocell or at a more centralized location/function). In another example where the macrocell has been assigned a Private_Cell_Support_Zone_ID, then only the subset of Private Cell to macrocell mapping information for the user in the Private_Cell_Support_Zone is obtained by the macrocell from the more centralized location/function and is retained as part of the MS's Handover Context information (either at the macrocell or at a more centralized location/function).

A user MS being served by a private cell or network can also be handed over a macrocell or other cell in a macrocell cellular network. As part of this handover process, the information on the neighboring macrocells of the serving private cell is obtained. In one implementation, the set of macro-cells that are potential handover targets from a specific Private Cell can be provided to that cell by the macro-cellular network the first time that this Private Cell registers a user with permitted access or from time to time as required if the potential macrocell handover target candidates change (e.g. perhaps due to some radio coverage reconfiguration of the macro-cellular network within the vicinity). As such, the Private Cell uses this information to build its neighbor list of handover target candidates which is used in the traditional fashion to evaluate neighboring cells for suitability as handover targets and to trigger handover to one of these macrocell targets when the appropriate condition is met.

Based on the above neighbor list, the handover target selection process can follow a MS-driven process, such as MS-initiated scanning, to select a macrocell to handover the MS. For example, a MS-initiated macrocell-to-macrocell handover procedure can be used where the setting values of the parameters of the handover target selection criteria are selected to condition the handover to some policy-based behavior, such as biasing service to the Private Cell unless quality of service becomes unacceptable versus using a best quality of Service condition.

The above examples illustrate a number of features for efficiently handling handover between a macro cell network and a private network. These features include sharing of list of valid users between the macro cell network and a private cell network to provide mapping between the macro cell and the corresponding neighbor private cells, and supporting dynamic update of the mapping between the macro cell and the corresponding neighbor private cells; adding new private cell to macrocell mapping information to the subscriber information; methods to provide the mapping information to a macrocell and to use the macrocell to determine the Private Cells for the user that are applicable to the macro-cell; using the network-initiated scanning of Private Cells and the Private Cell to Macrocell mapping information to determine suitability as handover targets, thus eliminating the need to add the Private Cells to the advertised neighbor cell list; and processing the measurements and applying any policy-based criteria as part of handover target selection. Various techniques for providing the mapping information to a macrocell can be used in various implementation, including sending a macrocell query to a more centralized location/function with only those Private Cells valid for the user and applicable to the macro-cell; operating a macrocell to extract the Private Cells in this list applicable to the macrocell from all Private Cell to Macrocell mapping information; providing the full set of Private Cell to Macrocell mapping information as part of the Handover Context information from the previous serving macro-cell; providing a defined subset of the Private Cell to Macrocell mapping information, as partitioned by Private_Cell_Support_Zone and transferred as part of Handover Context information from the previous serving macro-cell.

The handover techniques for handover between the private cells and the macrocells can be implemented to be compatible with handover processes between different macrocells. For example, one example of a wireless communication system that implements the present handover techniques can include a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; a first handover mechanism to perform a handover from the serving cell in the cellular wireless network to another cell in the cellular wireless network based on the list of neighboring cells for cells in the cellular wireless network; and a second handover mechanism to perform a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

A wireless communication system can implement one or more of the techniques described herein. In some implementations, a wireless communication system includes a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; and a mechanism to select radio cells in the one or more private wireless networks as candidate radio cells for handover of the mobile station from the serving cell in the cellular wireless network to one of the selected radio cells of the private wireless network. In some implementations, a wireless communication system includes a mechanism to select radio cells in the one or more private wireless networks as candidate radio cells for handover of the mobile station from the serving cell in the cellular wireless network to one of the selected radio cells of the private wireless network based on respective one or more proximities of the private wireless networks to the serving cell.

In another aspect, a wireless communication system can include a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; a first handover mechanism to perform a handover from the serving cell in the cellular wireless network to another cell in the cellular wireless network based on the list of neighboring cells for cells in the cellular wireless network; and a second handover mechanism to perform a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

In yet another aspect, a method for handling handover between a cellular wireless network and a private wireless network can include providing the cellular wireless network with information on access to one or more private wireless networks granted to a mobile station that is subscribed to the cellular wireless network and is being served by a cell of the cellular wireless network. Each of the one or more private wireless networks provides wireless access for a subset of all users subscribed to the cellular wireless network. This method can include operating the cellular wireless network to obtain mapping information between the serving cell in the cellular wireless network and radio cells in the one or more private wireless networks to which the mobile station is granted access; and selecting radio cells in the one or more private wireless networks as candidate radio cells for handover of the mobile station from the serving cell in the cellular wireless network to one of the selected radio cells of the one or more private wireless networks.

A wireless communication system can provide one or more mechanisms for a handover between a femtocell base station to different base station such as a macrocell base station or a different femtocell base station. A wireless communication system can provide one or more mechanisms for a handover between a macrocell base station to a femtocell base station. Various handover mechanism can use or provide handover candidate information.

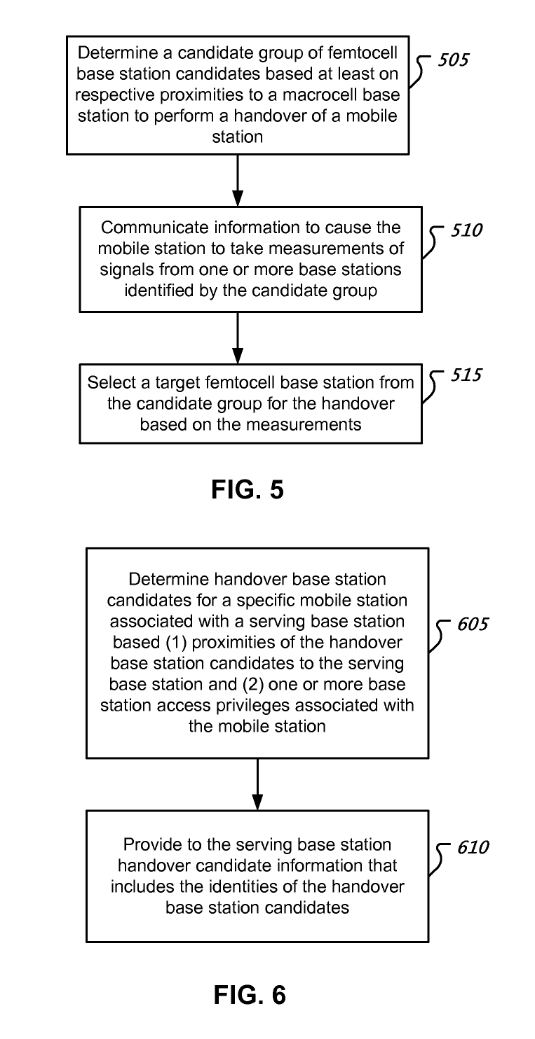

FIG. 5 shows an example of a handover operation between a macrocell and a femtocell. A wireless communication system can determine a candidate group of femtocell base station candidates based at least on respective proximities to a macrocell base station to perform a handover of a mobile station (505). The system can communicate information to cause the mobile station to take measurements of signals from one or more base stations identified by the candidate group (510). The system can select a target femtocell base station from the candidate group for the handover based on the measurements (515). In some cases, the mobile station can initiate the handover to the selected target femtocell base station. In some cases, the macrocell base station can initiate the handover to the selected target femtocell base station.

FIG. 6 shows an example of providing handover candidate information. A wireless communication system can determine handover base station candidates for a specific mobile station associated with a serving base station based information such as the proximities of the handover base station candidates to the serving base station and base station access privileges associated with the mobile station (605). The wireless communication system can provide to the serving base station handover candidate information that includes the identities of the handover base station candidates (610).

In other aspects, a macrocell base station in a wireless communication system can handover a mobile station to a femtocell base station. Business agreements relating to handover support between a femto system and a macro-cellular network can affect a handover process. A macro-cellular network can determine which private femtocell base stations grant access to a mobile station based on access privilege(s) associated with the mobile station, which can be based on a business agreement(s). Mobile station context information such as access privileges of a mobile station can be disseminated within the network to support various mobile station system operation such as handover.

A macro-cellular network can determine a list of one or more private femtocell base stations that are within a handover range of a base station currently serving a mobile station. In some implementations, the macro-cellular network can make such a determination based on the information such as geographic location, coverage area of the serving macro BS, and femtocell access privileges of the mobile station.

A macro-cellular network can maintain a handover candidate list of base station suitable for a handover of a specific mobile station. In some implementations, the macro-cellular network can maintain a handover candidate list of public femtocell base stations that neighbor the serving base station and grant access to the mobile station. In some implementations, the handover candidate list can include one or more of public or private femtocells and can include one or more macrocell base stations.

Based on the handover candidate list, the macro-cellular network can start to collect RF measurements to evaluate the potential handover target. In some implementations, the macro-cellular network can transmit the handover candidate list to the mobile station to cause the mobile station to take measurements of base stations on the handover candidate list. In some implementations, RF measurements can be collected via support of the mobile station to evaluate potential handover targets to be suggested to the MS without including potential target femtocell base stations in a neighbor cell list to be advertised to the MS.

The availability of a femtocell can change. For example, a femtocell base station may be powered on or off. Therefore, the availability of the private or public femtocell base station neighbor cell(s) may be periodically updated to the serving network. The serving network can use the availability information to update a mobile station context.

Based on the information acquisition, processing, and dissemination process described above, a list of femtocell base station scanning targets is identified by the macro cell base station to trigger a network-initiated scanning. To optimize the network-initiated scanning operation, the network can prioritize the list of the potential target femtocell base stations based on the private or the public femtocell access privilege(s) for the mobile station.

If the number of femto-BS scanning targets for the mobile station is greater than zero, the mobile station can be instructed by the serving macrocell base station via network-initiated target cell scanning procedure(s) to report an initial set of measurement for one or more of the targets. In some implementations, the mobile station can access a list of preferred femtocell base stations. For example, a mobile station can obtain such a preferred list via over-the-air (OTA) provisioning. The mobile station can prioritize the scanning targets based on service provisioning preferences such as the preferred list.

In some implementations, a network can transmit a mobile neighbor list advertisement (MOB_NBR_ADV) over a unicast channel to a specific mobile station to inform the mobile station about potential base station neighbors. Scanning femtocell base station information can be used to enable unicast MOB_NBR_ADV messaging which can include one or more macrocell base station neighbors. A broadcast MOB_NBR_ADV, such as one transmitted to multiple mobile stations, can include macrocell base station neighbor information. Such information can be used by the mobile station to initiate a scanning process. However, in some implementations, a broadcast MOB_NBR_ADV does not include information on private femtocell base stations.

When the mobile station completes the measurements and the scanning reports, the serving macrocell base station can process the measurement results from the network, and can determine one or more handover target femto base stations. In some implementations, the MS can use the measurement results to select one or more target base stations to trigger a handover operation. In some implementations, the mobile station can select handover targets according to the service provisioning preferences or other policies for selecting the handover targets.

A femtocell base station can handover a mobile station to another base station such as a neighboring femtocell base station or macrocell base station. A set of one or more of macrocell base station(s) or femtocell base station(s), that are the potential handover targets from the current serving femtocell base station, can be provided by the network when the mobile station attaches to the serving femtocell base station. Such information can be provided after the mobile station successfully enters or re-enters the network or after a successful MS handover to the serving femtocell base station. In some implementations, the serving femtocell base station can be updated periodically by the network with a list of neighbor targets based on changes in availability. The serving femto BS can use this information and the knowledge of its geographical location relative to those base stations in the list to determine the relative neighbor list for itself according to a specific mobile station. In some implementations, a serving femtocell base station can maintain a separate target neighbor list for each attached mobile station to the serving femtocell base station.

In some implementations, not all neighbor base stations in the list will be advertised by the femtocell base station in the in the broadcast MOB_NBR_ADV message, only the macrocell and the public femtocell base station in the neighbor list are included in the broadcast MOB_NBR_ADV. If the unicast MOB_NBR_ADV is supported in the network, then, the private femtocell base stations in the neighbor list can be sent to the mobile station for reference to determine an appropriate set of potential target base stations to handover to. If the unicast MOB_NBR_ADV is not supported, then the serving femtocell base station can initiate a network-initiated scanning to trigger the mobile station to scan for associated private femtocell base stations.

Based on the various neighbor list configurations as described in this specification, handover target selection process can support mobile station initiated scanning and network-initiated scanning. Some implementations can include setting parameters associated with handover target selection criteria to condition the selection process based on a policy-based behavior.

In some implementations, a wireless communication system can include a mechanism such as a digital processing apparatus to determine a candidate group of one or more femtocell base station candidates based at least on respective one or more proximities to the macrocell base station to perform a handover of a mobile station that is being served by the macrocell base station, wherein the one or more femtocell base station candidates provide wireless service in respective coverage areas that are smaller than a coverage area of the macrocell base station. The system can include a mechanism such as a base station to communicate information indicative of the candidate group to the mobile station to cause the mobile station to take measurements of signals from one or more base stations identified by the candidate group. The system can include a mechanism in a radio station such as a base station or a mobile station to select a target femtocell base station from the candidate group for the handover based on the measurements.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communications, comprising:
operating a macrocell base station to provide wireless service to mobile stations;
determining a candidate group of one or more femtocell base station candidates based at least on respective one or more proximities to the macrocell base station to perform a handover of a mobile station that is being served by the macrocell base station, wherein the one or more femtocell base station candidates provide wireless service in respective coverage areas that are smaller than a coverage area of the macrocell base station;
causing the mobile station to take measurements of signals from one or more base stations identified by the candidate group; and
selecting a target femtocell base station from the candidate group for the handover based on the measurements.

2. The method of claim 1, wherein determining the candidate group comprises selecting one or more private femtocell base stations based on one or more access privileges that grant access to the mobile station to communicate with the respective one or more private femtocell base station.

3. The method of claim 1, wherein determining the candidate group comprises selecting one or more one public femtocell base station candidates.

4. The method of claim 1, further comprising:
prioritizing the candidate group based on one or more access privileges associated with the mobile station, wherein causing the mobile station to take measurements comprises causing the mobile station to use a result of the prioritization to direct the taking of measurements.

5. The method of claim 1, wherein causing the mobile station to take measurements comprises causing the mobile station to use a service provisioning information to direct the taking of measurement, wherein the service provisioning information indicates a preferred base station scanning order.

6. The method of claim 1, wherein selecting the handover femtocell base station comprises operating the mobile station to select the handover femtocell base station based on the measurements.

7. The method of claim 1, further comprising:
receiving the measurements from the mobile station,
wherein selecting the handover femtocell base station comprises selecting the handover femtocell base station based on the received measurements.

8. The method of claim 1, wherein causing the mobile station to take measurements of base station signals comprises transmitting a unicast mobile neighbor base station advertisement over a unicast channel to the mobile station, wherein the unicast mobile neighbor base station advertisement includes one or more base station identifiers associated with one or more base stations included in the candidate group.

9. The method of claim 1, further comprising:
transmitting a broadcast mobile neighbor base station advertisement over a broadcast channel to multiple mobile stations, wherein the broadcast mobile neighbor base station advertisement includes one or more base station identifiers associated with the macrocell base station's one or more neighboring macrocell base stations; and
transmitting one or more base station identifiers associated with one or more base stations included in the candidate group in a unicast mobile neighbor base station advertisement over a unicast channel to the mobile station.

10. The method of claim 1, further comprising:
providing to the target femtocell base station one or more identities of base stations that are potential handover targets from the target femtocell base station for the mobile station.

11. The method of claim 10, wherein the one or more identities of base stations include an identity of a femtocell base station that grants wireless access to the mobile station.

12. The method of claim 10, wherein the one or more identities of base stations include an identity of a macrocell base station that grants wireless access to the mobile station.

13. A method for wireless communications, comprising:
determining one or more handover base station candidates for a specific mobile station associated with a serving base station based at least on respective one or more proximities of the one or more handover base station candidates to the serving base station and one or more base station access privileges associated with the mobile station; and
providing handover candidate information to the serving base station, wherein the handover candidate information includes one or more identities corresponding to the one or more handover base station candidates.

14. The method of claim 13, further comprising:
operating a cellular wireless network to provide wireless service to mobile stations via one or more macrocell base stations and to communicate with femtocell base stations associated with the cellular wireless network,
wherein the femtocell base stations provide wireless service in respective coverage areas that are smaller than a coverage area of a macrocell base station,
wherein the serving base station is one of the femtocell base stations.

15. The method of claim 13, further comprising:
providing updated handover candidate information to the serving base station based on a change of availability of handover base station candidates to server the mobile station.

16. A wireless communication system, comprising:
a cellular wireless network comprising a plurality of cells with base stations to provide wireless access to subscribed mobile stations, the cellular wireless network comprising a list of neighboring cells for cells in the cellular wireless network;
a private wireless network comprising one or more private cells to provide wireless access to a subset of the subscribed mobile stations in the cellular wireless network;
a mechanism to obtain mapping information between a serving cell in the cellular wireless network for a mobile station and radio cells in the private wireless network to which the mobile station is granted access; and
a mechanism to select radio cells in the one or more private wireless networks as candidate radio cells for handover of the mobile station from the serving cell in the cellular wireless network to one of the selected radio cells of the private wireless network based on respective one or more proximities of the private wireless networks to the serving cell.

17. The system of claim 16, comprising:
a mechanism to apply a selection condition to select one radio cell from the candidate radio cells as a target radio cell for the handover; and
a mechanism to perform handover of the mobile station from the cellular wireless network to the selected one target radio cell.

18. The system of claim 16, wherein the information on access to the private wireless network granted to the mobile station that is being served by the cell of the cellular wireless network comprises a list of cells in the private wireless network that are neighbors of the serving cell for the mobile station in the cellular wireless network.

19. The system of claim 16, wherein the cellular wireless network comprises macrocells, and at least one of a microcell located in a macrocell, or a picocell located in a macrocell.

20. A wireless communication system, comprising:
a macrocell base station to provide wireless service to mobile stations;
a mechanism to determine a candidate group of one or more femtocell base station candidates based at least on respective one or more proximities to the macrocell base station to perform a handover of a mobile station that is being served by the macrocell base station, wherein the one or more femtocell base station candidates provide wireless service in respective coverage areas that are smaller than a coverage area of the macrocell base station;
a mechanism to communicate information indicative of the candidate group to the mobile station to cause the mobile station to take measurements of signals from one or more base stations identified by the candidate group; and
a mechanism to select a target femtocell base station from the candidate group for the handover based on the measurements.

21. The system of claim 20, wherein the mechanism to determine the candidate group is configured to select one or more private femtocell base stations based on one or more access privileges that grant access to the mobile station to communicate with the respective one or more private femtocell base station.

22. The system of claim 20, wherein the mechanism to determine the candidate group is configured to select one or more public femtocell base station candidates.
